(19) United States
(12) Patent Application Publication
(10) Pub. No.: US 2006/0163462 A1
(43) Pub. Date: Jul. 27, 2006

(54) Localized hermetic sealing of a power monitor on a planar light circuit

(76) Inventor: Mohammad Eslamy, Palo Alto, CA (US)

Correspondence Address: TROP PRUNER & HU, PC, 8554 KATY FREEWAY, SUITE 100, HOUSTON, TX, 77024, US

(21) Appl. No.: 11/392,110

(22) Filed: Mar. 29, 2006

Related U.S. Application Data
(62) Division of application No. 10/393,562, filed on Mar. 21, 2003.

(51) Int. Cl. H01J 5/02

(52) U.S. Cl. 250/239

(57) ABSTRACT

A photodetector for power monitoring purposes may be positioned directly on a planar light circuit. The photodetector may be protected by hermetically sealing a localized region over the planar light circuit corresponding to the position of the photodetector. The remainder of the planar light circuit may remain unsealed.

### CROSS-REFERENCE TO RELATED APPLICATIONS

This application is a divisional of U.S. patent application Ser. No. 10/393,562, filed on Mar. 21, 2003.

### BACKGROUND

This invention relates generally to planar light circuits that transmit signals for optical communication systems.

Optical communication systems may convey a plurality of channels multiplexed as different wavelengths over a communication path. A plurality of signals multiplexed as different wavelengths may be conveyed to an intended destination. At the intended destination, the signals may be demultiplexed and/or split to form a plurality of output signals that may be transmitted to subscribers or other end users.

Thus, it may be important to know whether each channel has sufficient power. To this end, the demultiplexed signals may be conveyed through planar light circuits. Planar light circuits are integrated circuits with waveguides formed using semiconductor processing techniques. At periodic intervals, a trench may be formed into the planar light circuit so that light traveling in a core within that circuit is reflected upwardly. The upwardly reflected light may then be detected by an onboard photodetector.

Conventionally, the planar light circuit and the photodetector or power monitor are separate devices coupled by a fiber optic cable. By placing the photodetector directly on the planar light circuit, considerable efficiencies can be achieved.

However, power monitoring devices, such as photodiodes, exposed on top of planar light circuits may suffer from moisture exposure. Such exposure may cause increased dark current.

To this end, the entire planar light circuit and photodiode may be encapsulated within a container. But this is particularly expensive and makes connections to components on the planar light circuit more difficult.

Thus, there is a need for better ways to protect power monitors on planar light circuits.

### BRIEF DESCRIPTION OF THE DRAWINGS

FIG. 1 is a schematic, partial, enlarged cross-sectional view of one embodiment of the present invention;

FIG. 2 is an enlarged, partial, cross-sectional view of still another embodiment of the present invention;

FIG. 3 is an enlarged, cross-sectional view of one embodiment of the present invention;

FIG. 4 is a cross-sectional view taken generally along the line 4-4 in FIG. 3, in accordance with one embodiment of the present invention;

FIG. 5 is a cross-sectional view taken generally along the line 5-5 in FIG. 3, in accordance with one embodiment of the present invention;

FIG. 6 is a cross-sectional view corresponding to FIG. 5 of still another embodiment of the present invention; and

FIG. 7 is a cross-sectional view corresponding to FIG. 4 in accordance with still another embodiment of the present invention.

### DETAILED DESCRIPTION

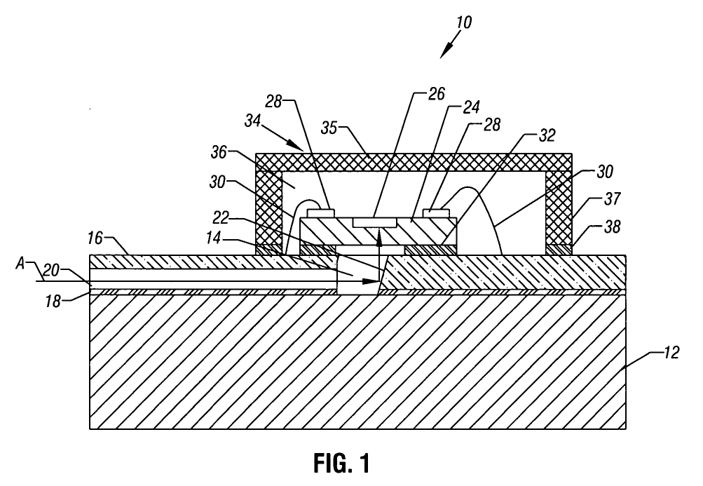

Referring to FIG. 1, in accordance with one embodiment of the present invention, instead of enclosing the entire planar light circuit 12, a localized region 36 may be hermetically sealed by a cover 34. Thus, only a portion of the exposed upper surface of the planar light circuit 12 is hermetically sealed, while the remainder remains unsealed and accessible for connections as necessary.

More particularly, a core 20 may convey a light signal A which may correspond to one channel of a particular wavelength of a previously multiplexed wavelength division multiplexed signal. This signal A, traveling through the core 20, may be subjected to power monitoring to determine whether that particular channel has the desired power characteristics.

The core 20 may be defined within an upper cladding 16 and a lower cladding 18 over the planar light circuit substrate 12. An interface or trench 14 may be defined through the cladding 16 and the cladding 18 in alignment with an end of the core 20. When the light signal A passes from the core 20 into the trench 14, it is reflected by a reflective surface 22, which may be angled with respect to the direction of incident light. As a result, the reflected light may be deflected upwardly to a photodetector 24.

The photodetector 24 may be mounted directly on the upper surface of the planar light circuit 12, for example, by an adhesive connection 32. The photodiode 24 may have an active area 26 that detects the incident light. In the case shown in FIG. 1, a bottom illumination system 10 is illustrated where the light passes through the photodiode 24 to the active area 26 on a side of the photodiode 24 opposite to the side adjacent the planar light circuit 12. Electrical contacts 28 may be coupled by wire bondings 30 to appropriate anode/cathode connections.

The region 36 may be encapsulated by a cap or lid 34, which in one embodiment may include a cylindrical wall 37 closed by a top 35. The cylindrical wall 37 may be secured to the planar light circuit 12 and, particularly, to the cladding 16, by a sealant 38.

The sealant 38 is effective to maintain a hermetically sealed region 36 within the cover 34. Generally, the sealant 38 is a preform or paste, which then may be melted when the entire assembly is put together, either in a furnace or using laser illumination. In some embodiments, the laser activated sealant may be more effective because there may be less stress applied through localized heating. In general, however, the sealant 38 is heated to seal the cover 34 to the planar light circuit 12.

In one embodiment, the sealant 38 is simply a vitreous glass layer. The vitreous glass layer directly bonds the cap or lid 34 to the planar light circuit 12. In one embodiment the cap 34 may be formed of aluminum nitride ceramic.

Alternatively, a soft solder or lead based solder may be used as the sealant 38. As still another alternative, hard solder, which is gold based, may be used as the sealant 38.

The top 35 may be joined to the wall 37 using a gold-tin preform in one embodiment when the top 35 and wall 37 are ceramic. As another alternative, a Kovar ring may be used to enable laser metal-to-metal welding between the top 35 which may be metal such as Kovar and the wall 37 which may be a ceramic such as aluminum nitride, in one embodiment. The Kovar ring may be brazed to the wall 37 that may be made of a non-metal such as a ceramic material. Then the top 35 is laser welded to wall 37 via the Kovar ring. Kovar is an alloy of nickel, cobalt, and iron.

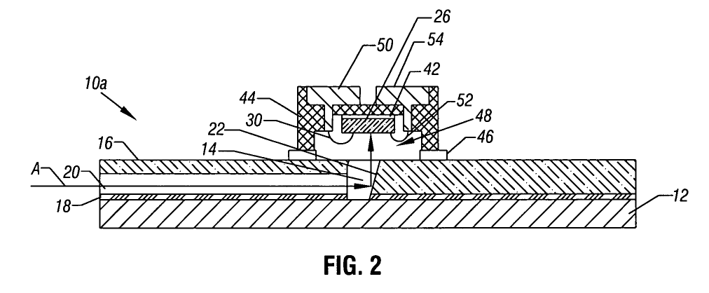

Referring to FIG. 2, a top illumination system 10a is illustrated. In this case, the photodiode 26 is exposed for direct illumination by the light A. A housing 44 may support an anode 50 and cathode 54 over the photodiode 26. External electrical contacts may be made to the anode and cathode 50 and 54.

A sealant 46 may be utilized between the wall 44 and the planar light circuit 12. The chamber 48 is again hermetically sealed. The photodiode 26 may be die attached by the adhesive 42. The adhesive 42 may be a silver filled glass, epoxy, soft solder, or hard solder, in some embodiments of the present invention for securing the die to the housing 44.

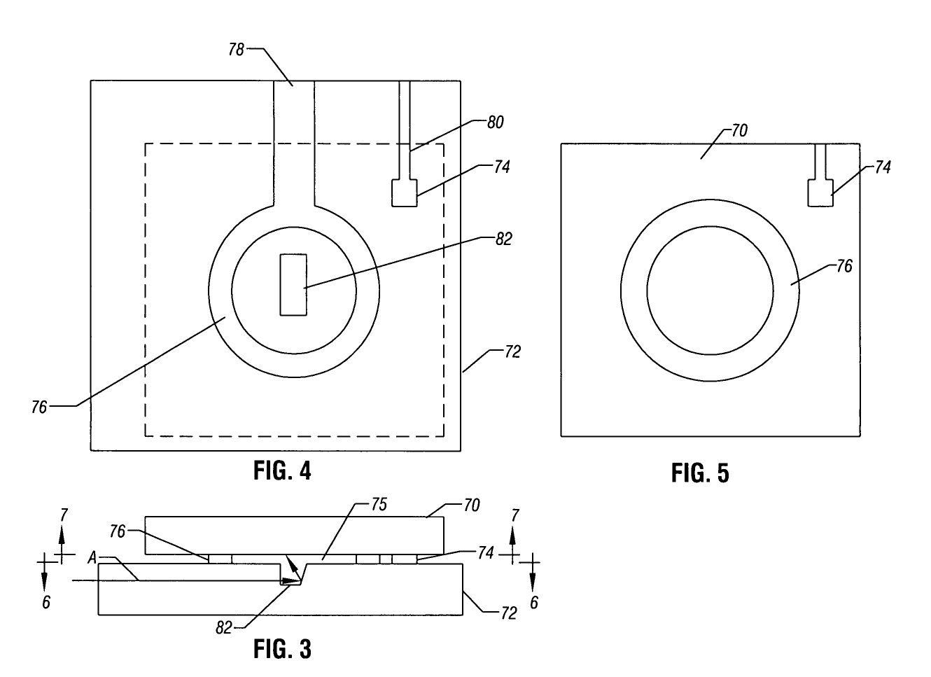

Referring to FIG. 3, in accordance with another embodiment of the present invention, the planar light circuit 72 may be sealed to the photodetector 70. In this example, there is no need for an encompassing cover 34 because the electrical connection between the planar light circuit 72 and the photodiode 70 also creates a localized, hermetically sealed chamber 75 at the single die level. In this case, the trench 82 receives the light signal A within the planar light circuit 72 and reflects it up to the photodetector 70.

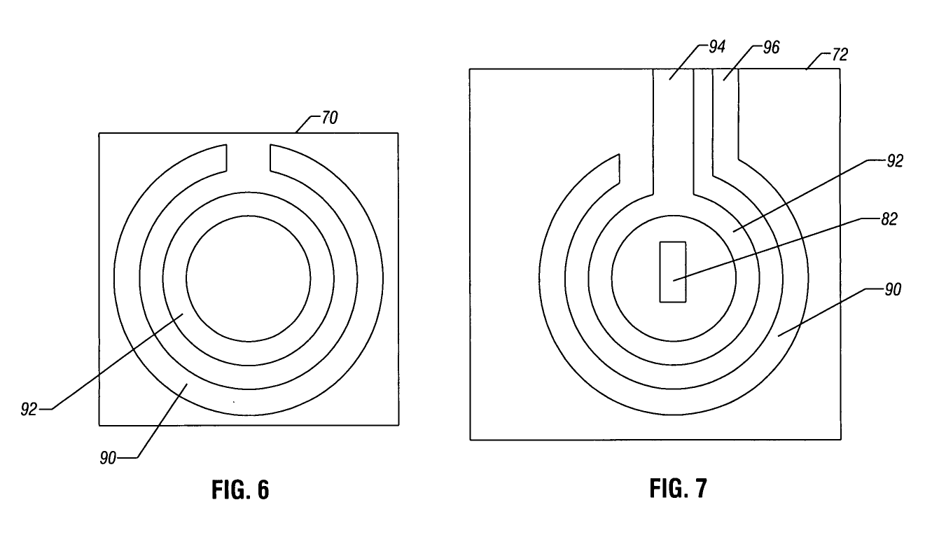

Referring to FIG. 4, the planar light circuit 72 includes a ring pad 76 that includes an extension 78 for external electrical connections. The ring pad 76 acts as an anode. An additional pad 74 acts as a cathode coupled by a connector 80 to the exterior. The ring 76 may circle the trench 82, as shown in FIGS. 6 and 5. The pads 76 may be in any closed geometric shape having a central opening including circles, squares, rectangles, and ovals, as a few examples.

As shown in FIG. 5, the photodetector 70 includes a corresponding ring 76 that matches the ring 76 on the planar light circuit 72. It may also include a contact 74 that matches the contact 74 on the planar light circuit 72.

Thus, the gold wire bonding pads on the photodiode 26, for example, may be changed to a ring pad 76 for the anode and an additional pad 74 in the corner for the cathode in one embodiment. The pads 74 and 76 may be gold pads deposited on the planar light circuit 72 and photodetector 70 in one embodiment. The two pieces (70, 72) are then bonded metallurgically at the interface of the ring 76 and contact 74 using flip chip or other surface mount techniques along with thermal compression.

As a result, not only may the wire bonding process from the photodetector to the planar light circuit be eliminated in some cases, but localized hermetic sealing may also be achieved. In some embodiments, lower costs may be achieved by eliminating the need for a hermetic package at the component level and also eliminating splicing and fusing between the planar light circuit and the photodetectors. In addition, in some cases, the gold wire bonding process for bonding the photodetector to the planar light circuit pads may be eliminated. The light traveling distance may be shortened by placing the photodetector directly on top of the planar light circuit while protecting the photodetector from exposure to extremes of humidity.

Referring to FIGS. 6 and 7, another arrangement for the anodes and cathodes is illustrated. In this case, the cathode 90 may be an outer open ring 90 and the anode 92 may be an inner, closed, concentric ring on the photodiode 70. Meanwhile, the planar light circuit 72 may include a cathode ring 90, a anode ring 92, and contact extensions 94 and 96 out to the edge for appropriate electrical connections. Each of the rings 90, 92 may be gold rings in one embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
coupling a photodetector onto a planar light circuit;
hermetically sealing a localized region of said photodetector over said planar light circuit; and
providing a surface mount connection between the photodetector and the planar light circuit and using thermo-compression to activate said connection and to provide a hermetically sealed localized region defined by said photodetector, said planar light circuit, and said surface mount connection.

2. The method of claim 1 including providing a metallic ring on each of said planar light circuit and photodetector, and bonding said rings to one another in response to thermo-compression.

3. The method of claim 2 including providing an electrical connection from one of said rings to an edge of at least one of said photodetector and planar light circuit.

4. The method of claim 1 including using the same connection that physically secures said photodetector to said planar light circuit to also provide a localized hermetically sealed region.

5. A planar light circuit comprising:
a substrate including a core to convey a light signal;
a photodetector positioned on said substrate so as to detect the light signal from the core;
a localized region of said photodetector over said planar light circuit being hermetically sealed; and
a surface mount connection between said photodetector and said substrate that forms a sealed hermetic localized region between said photodetector and said substrate.

6. The circuit of claim 5 including a pair of concentric rings formed of a surface mount material.

7. The circuit of claim 6 wherein said rings form the anode and cathode of said photodetector.

8. A planar light circuit comprising:
a substrate including a core to convey a light signal;
a trench formed in said substrate communicating with said core, said trench to reflect light from said core out of said substrate; and
a surface mount material formed on said light circuit in a closed geometric shape.

9. The circuit of claim 8 wherein said surface mount material is formed in a ring shape.

10. The circuit of claim 8 wherein said ring is part of an electrode for a photodetector.

11. The circuit of claim 8 including a pair of rings that form part of a pair of electrodes for a photodetector.

12. A photodetector comprising:
a light sensor; and
a pair of electrodes formed of surface mount material, one of said electrodes being formed in a closed geometric shape.

13. The photodetector of claim 12 wherein said closed geometric shape is a circle.

14. The photodetector of claim 13 wherein said circle encircles a light sensitive portion of said photodetector.

15. The photodetector of claim 14 wherein said circle forms an electrode of said photodetector.
